(19) United States
(12) Patent Application Publication
(10) Pub. No.: US 2007/0193005 A1
(43) Pub. Date: Aug. 23, 2007

(54) Pet lead and system for selection thereof

(76) Inventor: Craig John Chalk, Sydney (AU)

Correspondence Address: Red Dingo Inc, 5000 NW Village Park Dr #F236, Issaquah, WA, 98027, US

(21) Appl. No.: 10/599,138

(22) PCT Filed: Mar. 24, 2005
(86) PCT No.: PCT/AU05/00434

§ 371 Date: Sep. 21, 2006

(30) Foreign Application Priority Data
Mar. 24, 2004 (AU) 2004901554

(51) Int. Cl. F16B 45/00

(52) U.S. Cl. 24/265 H

(57) ABSTRACT

A system and method for selecting a pet lead or collar configuration at point of sale. The system comprises an arrangement for storing, in a disassembled configuration, a number of pet lead or collar components, sufficient and configurable to assemble a pet lead and/or collar. A pet lead and collar and an attachment means (15,16) for the pet lead or collar. A clip (7c) for a pet lead or collar is disclosed, the clip being configured in the shape of an animal, with a portion of the anatomy of the animal being mechanically associated with the operation of the clip.

### FIELD OF THE INVENTION

The present invention relates to a pet lead, a pet collar and a system for selecting a pet lead configuration at point of sale. The present invention also extends to unique components for the pet lead.

### BACKGROUND TO THE INVENTION

Presently, when an owner of a pet enters a store to purchase a pet lead they are presented with a limited number of choices. These are variation in lead length and colour, and variation in collar type and colour. In addition, if stores wish to offer a variety of pet leads to a customer, a number of different types of assembled leads must be stocked. However, almost all such leads have an industry standard clip design, being shaped somewhat like the clip shown in FIG. 12. Furthermore, some stores may not be able to support a large range of leads, due to either financial or storage constraints, and thus often an insufficient variety of leads is offered to the customer at the point of sale. For example, the range of leads a store can stock is often determined by available shelf and/or overall space, rather than by any extensive range available at wholesale. Therefore, presently even if a store desired to sell a variety of leads or collars it would be difficult for the aforementioned reasons.

Currently, many pet leads offered for sale are fairly plain in appearance and not aesthetically pleasing to a customer, partly because most if not all such leads employ the industry standard clip design referred to above. Furthermore, some of these pet lead designs are not particularly functional or an appropriate size, and for some users (eg disabled users) the industry standard clip design can be difficult to use.

If a store wanted to stock leads with different clip configurations, usually the number of leads needed to be stored would be a multiple number of different clip types desired and, again this would lead to an excessive storage requirement.

It would be advantageous if a pet lead could be readily produced, and that is functional and aesthetically pleasing.

### SUMMARY OF THE INVENTION

In a first aspect the present invention provides a system for selecting a pet lead configuration at point of sale, the system comprising an arrangement for storing, in a disassembled configuration, a number of pet lead components sufficient and configurable to assemble a pet lead.

In a second aspect the present invention provides a system for selecting a pet collar configuration at point of sale, the system comprising an arrangement for storing, in a disassembled configuration, a number of pet collar components sufficient and configurable to assemble a pet collar.

That the components are “sufficient and configurable” to assemble a pet lead or a pet collar means that the customer and/or a sales assistant can produce a finished pet lead or collar from the components.

Preferably, the system further comprises an assembly facility that enables components selected from the arrangement to be assembled into the pet lead or collar configuration at point of sale. The point of sale includes any facility or location associated with the seller of the lead or collar. For example, the point of sale may be a cash register or anywhere in a store that sells the leads or collars. Whilst advantageously the assembly facility will be provided at the point of sale, the components are also configurable (eg. configured and/or adapted) such that they can be assembled by a customer at a facility (eg at a home workshop) remote from the point of sale.

The system according to the invention enables a “mix and/or match” capability to be provided at point of sale to a customer wishing to purchase a pet lead or collar. Thus, a wide variety of pet lead or collar configurations can be made available to the customer by providing multiple different components in unassembled forms. In addition, because the unassembled components can be grouped, for example, tight-packed or placed adjacently, a reduction in storage space can be achieved. This enables existing stores to provide a large variety of pet lead or collar configurations, without requiring a much larger number of assembled pet leads or collars to be in stock at any one time. The system according to the invention also provides a greater opportunity for a customer to personalise or customise a pet lead or collar eg. in terms of functional and/or aesthetic considerations.

This system is of particular benefit to people with disabilities. The mix-and-match system enables a disabled customer to customise a lead/collar to suit their particular needs. For example, handles and/or clips can be provided that are particularly suited to a customer having arthritis or another ailment where hand movement is impaired. More specifically, padded handles and easily opened clips may be provided.

The components of a pet lead provided in accordance with the present invention typically comprise a plurality of each of a clip configured for releasable attachment to a collar, and a leash for fastening attachment to the clip. In addition, the components may comprise a plurality of collars configured to be worn by a pet and/or a plurality of rings (or links) for attaching the clip to the collar. A plurality of different types and styles of each component can also be employed.

A releasable attachment means can be employed for releasably attaching the clip to a proximal end of the leash. This enables a customer to change, swap or replace components (eg for variety, because of usage concerns, or due to component failure, wear etc). Alternatively, once the clip is attached to the leash, it may be permanently affixed thereto. The attachment means can be associated with either or both of the clip and leash.

Typically a distal end of each leash is configured to be held by a person.

The assembly facility can be configured such that a purchaser (customer) of the lead or collar can assemble the components into a desired pet lead or collar configuration. In this regard, the assembly facility can include simple tools, instructions etc. This gives customers the satisfaction of building their own lead or collar. In addition, the storage arrangement and assembly facility can be positioned in proximity of each other such that selected components can be immediately assembled into a desired pet lead or collar configuration.

Typically, the pet lead or collar components are sufficient and configurable for manual assembly of the pet lead or collar. The manual assembly may be by hand and/or by the use of tools.

In a third aspect the present invention provides a method for enabling selection of a pet lead or collar configuration at point of sale, comprising the step of, at point of sale, providing a number of pet lead or collar components sufficient and configurable to assemble a pet lead or collar.

Preferably, at point of sale, the method also provides for assembly of the selected components into the pet lead or collar configuration.

In the implementation of this method, the interaction of the customer with the staff of the store, and the customer's involvement in the component choice and/or fabrication of their own lead or collar, can result in greater customer satisfaction. Satisfaction is also enhanced because the customer is more involved in the lead or collar optimisation process. The method of the second aspect is otherwise operated as per the system of the first aspect of the invention.

In a fourth aspect the present invention provides a pet lead and collar, the pet lead comprising a clip configured for releasable attachment to a pet; and an attachment means for releasable attachment of the clip to an elongate member.

The pet collar components typically comprise a plurality of each of an elongate member for forming into a loop to define a body of the collar; and a coupling component fastenable to the elongate member and enabling releasable attachment to a leash.

A pet collar comprising a clip configured for releasable attachment to a pet lead, identification tag or other collar depending object; and attachment means for releasable attachment of the clip to an elongate member of the collar is also provided. The elongate member may have a shackle attached thereto, whereby the attachment means releasably connects the shackle with the clip.

A pet collar is also provided comprising a clip configured for releasable attachment to a pet lead, identification tag or other collar depending object, and the clip being attached to an elongate member of the collar.

As stated above, by providing an attachment means that is releasable, a customer can readily change, swap or replace components.

Typically the elongate member has a shackle attached to one end, and the attachment means is configured to releasably connect the shackle with the clip.

In a first variation the attachment means comprises a male portion mountable to the shackle or clip; and a female portion mountable to the clip or shackle respectively and adapted for receiving the male portion therein such that, when engaged, the male and female portions attach the clip and shackle together.

In this first variation part of the male portion can be externally threaded and part of the female portion can be internally threaded, for screw coupling together of the male and female portions. In addition, a sleeve can be mounted on the shackle or clip, with the female portion being insertable into one end of this sleeve and the male portion being insertable into an opposite end of this sleeve. The female portion can be snugly received in the sleeve whereas the male portion can be provided with an enlarged head protruding out beyond the female portion and sleeve, which enables the male and female portions and the sleeve to be attached together.

Alternatively in this first variation, the male portion can comprise a shank and the female portion can comprise a sleeve. The shank can be insertable through the sleeve such that a free end protrudes therebeyond. The shank free end can then comprise a groove that is adapted for engagement by a circlip that has a perimeter greater than an inner dimension of the sleeve (eg the circlip having a perimeter diameter that is greater than an inner diameter of the sleeve).

In another alternative of the first variation, the male portion can comprise a shank and the female portion can comprise a sleeve. The shank can be inserted into the sleeve such that a free end is located within the sleeve. The shank free end can comprise a groove that is alignable with a slot defined in a side wall of the sleeve. The groove can be adapted for engagement by a circlip insertable through the slot whereby, once the circlip is inserted through the slot and engaged on the groove, it locks the shank in the sleeve.

In yet another alternative of the first variation, the male portion can comprise a shank having a lug at a free end thereof and the female portion can comprise a sleeve having a slot in a side wall thereof that is shaped to laterally receive the shank and lug therethrough. The attachment means can then further comprise a plug shaped for fastening receipt in the sleeve slot whereby, once the shank and lug have been inserted through the slot, the plug can be inserted and fastened into the slot to lock the shank and lug in the sleeve.

In a further alternative of the first variation the male portion can comprise a shank having a lug at a free end thereof and the female portion can comprise a sleeve having a slot in a side wall thereof that is shaped to laterally receive the shank and lug therethrough. Once inserted laterally, the shank and lug are then able to move longitudinally, seating the lug in a seat. To remove the shank and lug from the sleeve, they must first be moved longitudinally and then laterally out of the sleeve slot. The attachment means then further comprises a plug shaped for fastening receipt in the sleeve slot, whereby the plug is inserted into a position longitudinally adjacent the lug and prevents the lug moving longitudinally. In this case there can be very little strain or stress on the plug, yet it is still able to lock the lug in the sleeve.

In one example, the plug can have opposing projecting fingers, each having a hooking means at a free end thereof. An internal wall of the sleeve can then have corresponding holes defined therethrough, with each hole being located for receiving a respective hooking means therein to fasten the plug in the sleeve when it has been inserted into the slot. In this example a portion of the shackle can extend through the sleeve, whereby the lug can sit under the shackle portion whereas part of the plug can extend over the shackle portion, to thereby sandwich the shackle portion between the lug and plug part. The shackle may still be able to swivel in the sleeve.

In a second variation the shackle can be in the form of a karabiner and through an opening of which is passed an aperture defined in an end of the clip and/or a looped end of the elongate member. In this variation, a sleeve can be mounted to the karabiner, and a shank can extend from the clip and be inserted through the sleeve such that a free end protrudes therebeyond. The shank free end can be swaged so as to have a perimeter that is greater than an inner dimension of the sleeve to thereby fasten the clip to the karabiner. Alternatively, male screws or circlips as per the first variation can be employed with the shank. In an alternative embodiment the karabiner and clip are either integrally formed or fixed to each other.

In a third variation an end of the elongate member can be looped and the attachment means can comprise a shackle which passes through the loop or an aperture in the clip, and a pin for the shackle which passes through the aperture in the clip or loop respectively. In this variation the pin typically has a threaded end and an opposing enlarged head. The threaded end can be screwed into a threaded recess defined at a free end of one arm of the shackle, and the enlarged head can be restrained at a recess defined at a free end of another arm of the shackle. Typically the shackle is U-shaped. In an alternative embodiment the shackle and clip are either integrally formed or fixed to each other.

In a fourth variation the attachment means comprises a link that extends through a looped end of the elongate member and an aperture in the clip to connect the two together. The looped end of the elongate member is enabled by a shackle and pivot pin arrangement in which a free end of the elongate member is looped back through the shackle and the pivot pin of the shackle is inserted through a hole in the free end to lock the same against movement in the shackle. In an alternative embodiment the link and clip can be either integrally formed or mounted to each other.

In a fifth variation the attachment means comprises a link that extends through a looped end of the elongate member and an aperture in the clip to connect the two together. The looped end of the elongate member is defined by folding back a free end of the elongate member and releasably fastening it against an adjacent part of the elongate member. In this variation the elongate member free end can be releasably fastened against the adjacent part through the arrangement of one or more press studs, rivets or threaded studs therebetween. In an alternative embodiment the link and clip can be either integrally formed or mounted to each other.

The link of the fourth and fifth variations can comprise a closed oval-shaped/rectangular ring.

In a sixth variation the attachment means comprises a first link that extends through a looped end of the elongate member and a second link that extends through an aperture in the clip. One of the first or second links can be connected to a stem of a T-piece, and the other of the second or first links can be connected to a body having a T-shaped slot defined therein for receipt of the T-piece to connect the first and second links together. In this variation the T-piece and body are typically each elongate, and the T-shaped slot extends longitudinally through the body and defines a T-shaped opening to the slot at an end thereof. The elongate T-piece can be slid through this opening and into the slot to connect the first and second links together. In addition, a grub screw or pin can be mounted to extend through the T-piece and into the body when the T-piece is located in the body to lock the first and second links together. Alternatively, the first link and clip can be integrally formed or mounted to each other.

In a seventh variation the attachment means comprises a body having a hollow interior and an aperture to that interior, the body connected to the elongate member or clip. The attachment means further comprises a shank connected to the clip or elongate member respectively, the shank having a lug at a free end thereof. The lug has a greater cross-sectional dimension than that of the aperture, but is sized to fit within the body hollow interior. At least one of the lug and/or body is deformable or flexible such that the lug can be inserted through the aperture and into the hollow interior, to connect the elongate member and clip together. In this regard, one or both of the lug and/or body can be formed of a deformable or flexible material such as a plastic, flexible metal etc.

In an eighth variation the attachment means comprises a body connected to the elongate member or clip, the body having a hollow interior and an aperture to that interior, with a ring element located within the hollow interior in use. The attachment means further comprises a shank being connected to the clip or elongate member respectively, the shank having a groove for receiving the ring element therein when the shank is located in the hollow interior. The groove is located adjacent to a free end of the shank. At least one of the shank and/or ring element is deformable or flexible such that the shank can be inserted through the aperture and into the hollow interior until the ring element rides into the groove to connect the elongate member and clip together. In this regard, one or both of the shank and/or ring element can be formed of a deformable or flexible material such as a plastic, flexible metal etc. However, typically the ring element comprises a circular spring which is deformed as the shank moves therepast, and which springs into the groove once it is aligned therewith.

In all of the variations defined above, typically the elongate member is a leash or strap that includes a handle at a remote end thereof.

The clip can also be modified to make it easier to use. For example, when the clip has a spring-loaded pin defining a gateway to an aperture of the clip, a protruding hook can extend outwardly from the pin and be adapted for receiving a user's finger thereat to enable urging of the pin against the spring to open the gateway. The hook can be J or U-shaped and be sized to receive a user's finger snugly therein. Thus, an improvement to an existing industry standard clip be made by attaching (eg. through integral forming) a hook thereto, which can make the clip easier to use (eg. easier to open) by a disabled, young or old etc user of the clip.

As another modification to make the clip easier to use, a gateway to an aperture of the clip can be defined by an elongate member pivotally mounted intermediate its ends to the clip to define a lever portion of the member extending away from the clip that can be actuated by a user's hand, with an opposite end of the member defining a gate portion to the gateway that can be pivoted open and closed by actuation of the lever. In this regard, typically the clip has an elongate body with a head at a remote and thereof, the head defining the aperture and the gateway thereto, and wherein the elongate member is pivotally mounted to the clip adjacent to the head such that the lever portion extends from one side of the clip body and the gate portion extends from an opposite side. In addition, the elongate member is typically biased by a spring into the gateway closed position.

Employing a lever-type arrangement makes the clip even easier to use for disabled and handicapped users, the young and elderly etc, with the gripping of the lever and clip body being readily and simultaneously effected.

In a ninth variation, the present invention provides a clip as defined above having either of the modifications as described.

In a fourth aspect the present invention provides an attachment means for use with a pet lead or collar for attaching a clip of the pet lead or collar to a strap of the pet lead or collar, the attachment means being as defined above in the third aspect.

In a fifth aspect the present invention provides a clip for a pet lead or collar, characterised in that the clip is configured in the shape of an animal, and a portion of the animal's anatomy is mechanically associated with the operation of the clip.

The animal shaped clip option is ingenious since it can satisfy both functional and aesthetic considerations simultaneously. Aesthetically, it is particularly appropriate since the clip is to be used in conjunction with an animal. Furthermore, the mechanical connection between the ear and jaw of the dog is both functional and playful.

The portion of the animal's anatomy typically comprises a latching means for opening the clip and enabling it to be clipped onto a shackle or ring. For example, the latching means can be characterised in that opposing portions thereof are configured in the shape of an ear and a jaw of the animal such that, by moving the ear portion of the latching means, the jaw portion of the latching means can move between open and closed positions. However, the latching means can be configured in the shape other anatomical parts of the animal.

The latching means is typically in the form of a lever arm pivotally mounted intermediate its ends to a remainder of the clip, with one end of the lever arm defining a protruding ear of the animal shape for manual engagement by a user, and the other end of the lever arm defining a jaw portion of the animal shape that can move to open onto an open mouth portion of the animal shape and into which a loop of a shackle or ring can be located, and then this other end of the lever arm can be closed to latch the shackle or ring therein.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a plan view of the end of a pet lead in accordance with a first preferred embodiment;

FIG. 2 is a plan view of the end of a pet lead in accordance with a second preferred embodiment;

FIG. 3 is a plan view of the end of a pet lead in accordance with a third preferred embodiment;

FIG. 4 is a plan view of the end of a pet lead in accordance with a fourth preferred embodiment;

FIG. 5 is a side view of the pet lead embodiment of FIG. 4;

FIG. 6 is an end view of the pet lead embodiment of FIG. 4;

FIG. 7 is a plan view of the end of a pet lead in accordance with a fifth preferred embodiment;

FIG. 8 is a side view of the pet lead embodiment of FIG. 7;

FIG. 9 is a plan view of the end of a pet lead in accordance with a sixth preferred embodiment;

FIG. 10 is a plan view of the end of a pet lead in accordance with a seventh preferred embodiment;

FIG. 11 is a plan view of the end of a pet lead in accordance with an eighth preferred embodiment;

FIG. 12 is a plan view of the end of a pet lead in accordance with a ninth preferred embodiment;

FIG. 13 is a plan view of the end of a pet lead in accordance with a tenth preferred embodiment and illustrating a new type of clip arrangement in a clip-closed configuration;

FIG. 14 is a plan view of the pet lead embodiment of FIG. 13 in a clip-open configuration;

FIGS. 15A-F are plan views of alternative clip arrangements to those of FIGS. 13 & 14;

FIGS. 16A-E are plan views of the end of a pet lead in accordance with an eleventh preferred embodiment;

FIGS. 17A-E are plan views of the end of a pet lead in accordance with an twelfth preferred embodiment;

FIG. 18 is a schematic depiction of a system for selecting a pet lead configuration at point of sale in accordance with the present invention;

FIG. 19 is a plan view of an alternative clip configuration in accordance with another embodiment of the invention; and

FIG. 20 in a plan view of yet another alternative clip configuration in accordance with another embodiment of the invention.

### MODES FOR CARRYING OUT THE INVENTION

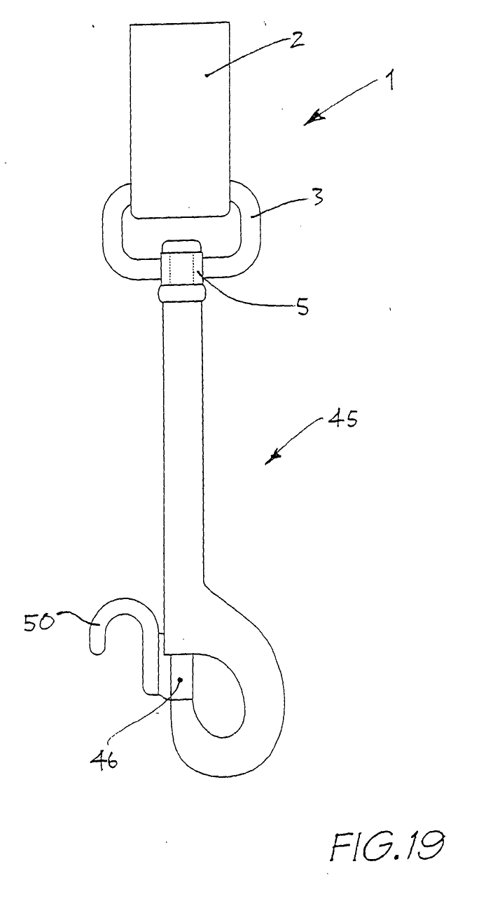

Referring firstly to FIG. 18, a method and system 100 for selecting a pet lead configuration at point of sale is shown schematically as comprising an arrangement in the form of stands 102,104 holding a number of pet lead components sufficient to assemble a pet lead. An optional assembly facility is shown in the form of a work station 106 that enables selected components from the stands 102,104 to be assembled into a desired pet lead configuration.

In this regard, stand 102 carries a number of different clip types 108, a number of different shackle types 109, and a number of different collar types 110. Stand 104 carries a number of different lead types 112. Work station 106 carries a number of different tool types 114 which enable the lead components to be assembled into a finished product. More compact storage and display facilities can of course be employed, including display boxes, drawers, shelves etc.

In use, a purchaser can select the clip, shackle, collar and lead that they want, take them to work station 106, assemble them (or have a store attendant assemble them) and then purchase a finished product from a sales counter (that may be adjacent to the work station 106). In this way the purchaser can select clip type, shackle type, lead type and collar type that they like (eg having matching or mixed colours, styles, aesthetics etc).

Whilst optionally the assembly facility will be provided at the point of sale, the components may be configured and/or adapted such that they can be assembled by a consumer at a facility (eg a home workshop) remote from the point of sale.

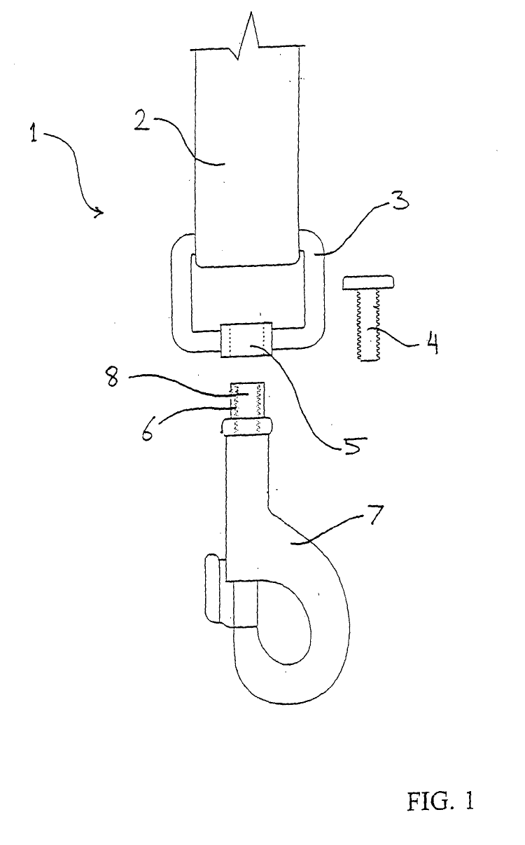

FIGS. 1 to 14, 16 and 17 show various attachment mechanisms that can be employed with the system of FIG. 18, for releasably (or permanently) attaching a clip to a lead.

Referring now to FIG. 1, an end portion of a pet lead 1 comprises a leash or strap 2 and a shackle 3 located in a looped end portion of strap 2. A mechanism for releasably or permanently attaching a clip 7 to the strap comprises a screw 4, a collar 5 and an internally threaded screw receiving recess 6 defined in a shank 8 of the clip 7. The shank 8 is also configured for removable insertion into the collar 5. When shank 8 is inserted in collar 5 the screw 4 may then be screwed into the screw receiving recess 6 to secure the assembly together. The screw can be insertable up to a specified depth that still allows for swivelling of the shank in the collar.

When this mechanism is used at the point of sale, a customer can choose a desired strap 2 and shackle 3 arrangement, and clip 7, and then have the components assembled (or self-assemble them) in the store or elsewhere to form the pet lead of their choice.

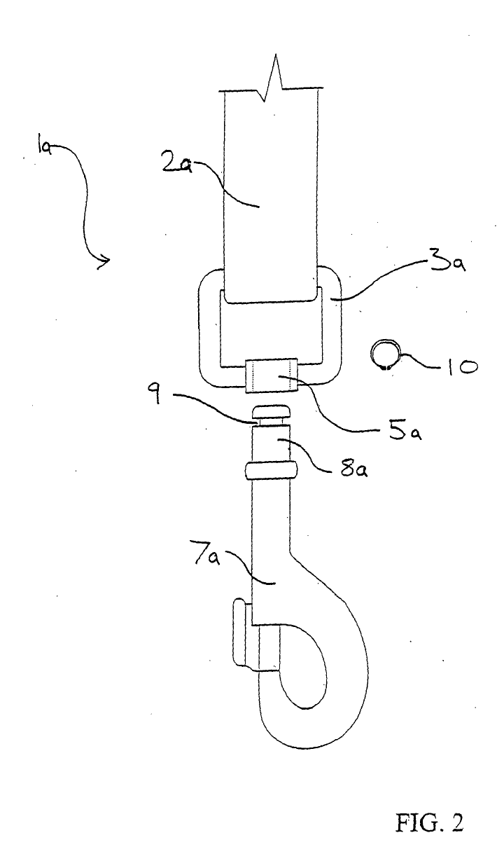

Turning now to FIG. 2, similar reference numerals to those used in FIG. 1 denote similar or like parts. In this embodiment, the shank 8a incorporates a recess or groove 9 around its circumference near its free end. As in the first embodiment, the shank 8a is configured for removable insertion through collar 5a. However, in this embodiment, the assembly is held together by locating a circlip 10 within the recess 9 once the shank 8a has been inserted through to protrude beyond the collar 5a. The circlip has a fitted diameter that is greater than the diameter of the interior of collar 5a, thus preventing shank removal from the collar but allowing for swivelling of the shank in the collar.

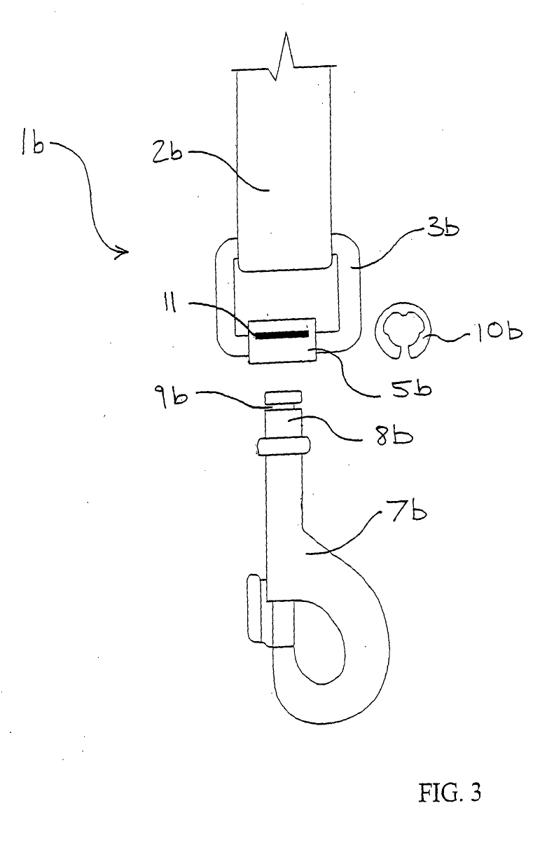

Referring now to FIG. 3 another mechanism for releasably or permanently attaching a clip to a strap is shown, again where similar reference numerals as those used with previous embodiments denote similar or like parts. In this embodiment the column 8b has a recess or groove 9b similar to that in the embodiment of FIG. 2. In this embodiment, however, once the column 8b is inserted into the collar 5b it can be locked in place by a circlip 10b which engages with the groove 9b after being inserted through a slot 11. In this regard, the slot 11 extends through a wall of the collar 5b and is configured to accommodate the circlip 10b. Once inserted, the circlip 10b sits within groove 9b and also on an integral ledge within collar 5b, defined in part by the slot 11. In addition, once the circlip 10b engages the groove 9b, the connection is more permanent than in the embodiment of FIG. 2, as the circlip 10b is retained within the collar and is difficult to manually access and disengage.

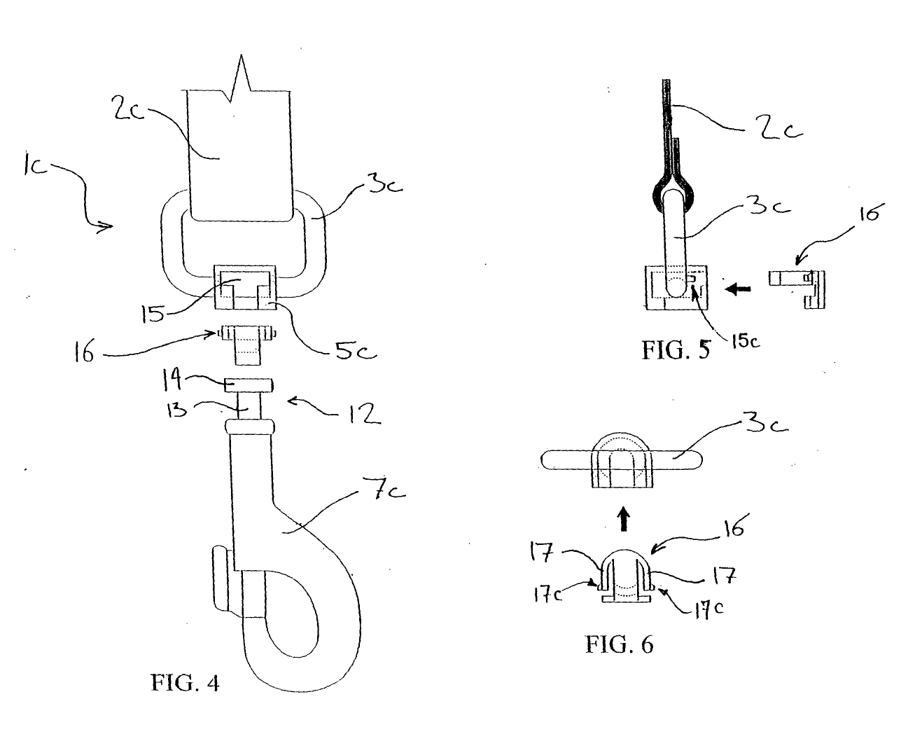

FIGS. 4, 5 and 6 show another mechanism for releasably or permanently attaching a clip to a strap and employ similar reference numerals to those used with previous embodiments to denote similar or like parts. The clip 7c of this embodiment incorporates an integrally formed lug 12 projecting from an end of the clip 7c. The lug 12 comprises a shank section 13 and a head 14 of larger diameter than and located at the end of the shank section 13. The collar 55c incorporates a T-recess 15 in its side wall which is shaped to receive the lug 12 therethrough. Once inserted, the head 14 is positioned to sit under shackle 3c against an internal seat in the collar. That is to say, the head 14 enters the T-recess 15 laterally and is then moved a small distance longitudinally (down) until it rests adjacent the seat, such that to remove the lug 12 from the T-recess 15 it must first be moved longitudinally (up) before being removed laterally. The lug 12 is locked into the recess 15 by inserting a locking plug 16 into the recess 15 to in part sit over the shackle 3c and longitudinally adjacent the lug 12.

The locking plug 16 is configured for releasable but locking engagement with the recess 15 by way of two outwardly biased arms 17. In this regard, each arm has a hook 17c at a free end thereof which, once the plug is inserted, locks into a respective hole 155c through a wall of collar 5c. The hooks 17c can also be push-pressed out of their holes 155c to effect the release of the locking plug 16 from the recess 15, and this to enable release of lug 12 from collar 5C.

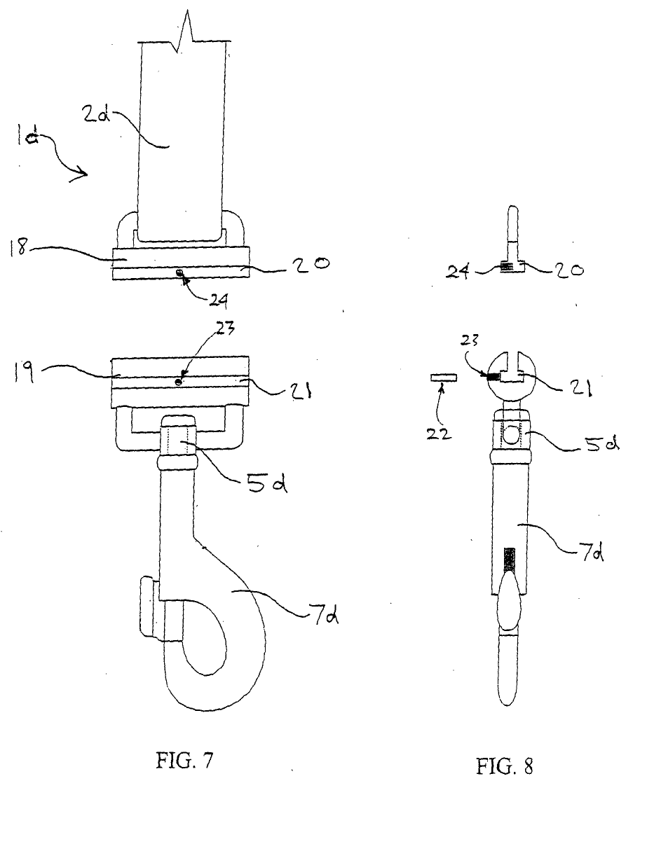

Turning now to FIGS. 7 and 8, in which similar numerals are used as with previous embodiments to denote similar or like parts, another mechanism for releasably or permanently attaching a clip to a strap is shown. This embodiment incorporates a dividable shackle arrangement comprising a strap shackle section 18 and a clip shackle section 19. The strap shackle section 18 receives the strap 2d through its centre aperture as in previous embodiments. Preferably, section 18 is T-shaped in end view, with a cross portion of the T-shape defining a male lug 20. The clip shackle section 19 comprises a collar 5d, the collar 5d being attached as shown to the clip 7d (eg using a mechanism as in FIGS. 1 or 2, or being a swaged-over shank end).

The clip shackle section 19 has a corresponding T-shaped female recess 21 extending longitudinally therethrough for receiving the stem and male lug 20 of the T-shaped projection of shackle section 18. The stem and male lug 20 can be locked within the female recess 21 by first inserting the stem and male lug 20 into the female recess 21 and by then inserting a pin or grub screw 22 through an aperture 23 in the wall of the clip shackle section 19 and then into an aligned recess 24, formed in the male lug 20. The shackle sections can also be reversed.

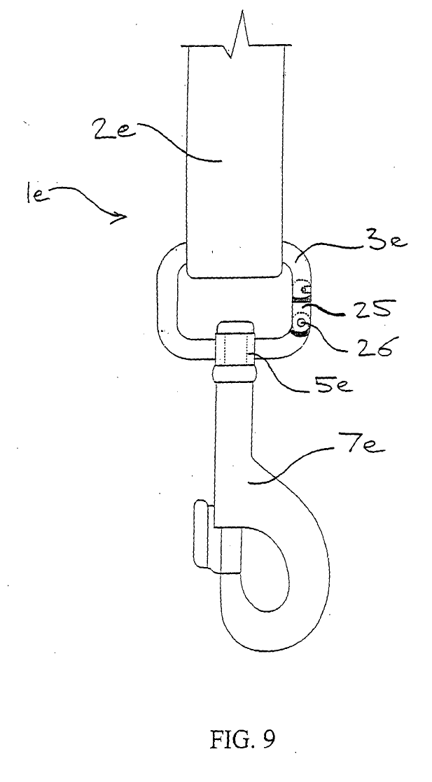

Referring now to FIGS. 9 to 14, 16 and 17 it should again be noted that like reference numerals denote similar or like parts to previous embodiments. In addition, other mechanisms for releasably or permanently attaching a clip to a strap will now be described.

Referring to FIG. 9, there is shown a pet lead 1e with a collar 5e and clip 7e arrangement similar to the embodiment of FIG. 7. However, this embodiment utilises a karabiner-style metal loop for the shackle 3e which allows the clip 7e and/or a loop defined at an end of the strap 2e to be removably associated to each other. The karabiner-style shackle 3e incorporates a gate 25 that pivots about a pivot point 26 but is biased closed via a spring mechanism operating between the gate and pivot.

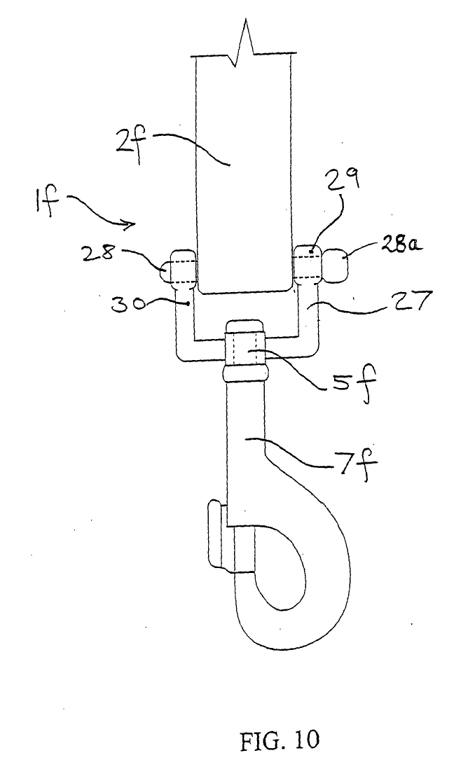

Referring now to FIG. 10, in the pet lead 1f a U-shaped shackle 27 is employed to attach the strap 2f to the clip 7f. The shackle has a base that incorporates a collar 5f, in turn attached to clip 7f. An externally threaded shackle pin 28 is passed through an unthreaded aperture in the shackle arm 29, then through a loop defined at the end of the strap 2f, and then screws into an internally threaded aperture in the shackle arm 30. The pin 28 has an enlarged head 28a opposing its externally threaded end.

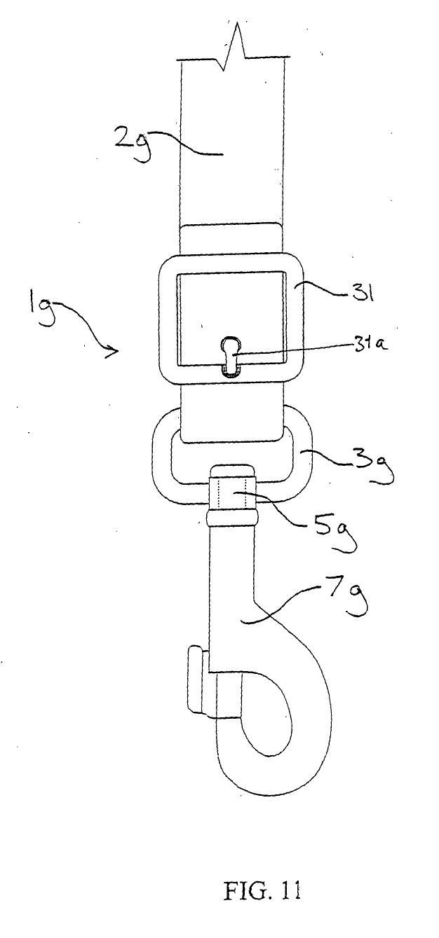

Referring now to FIG. 11 the lead 1g comprises a ring link 3g attached to the clip 7g via a collar 5g. The strap 2g is looped at one end and has a belt-type buckle 31 incorporated into the loop which allows the loop to be opened and closed. When the loop is opened, a portion of the strap 2g can be passed through the centre of the ring link 3g and then the loop can be closed again using the belt buckle 31 to attach the clip to the strap.

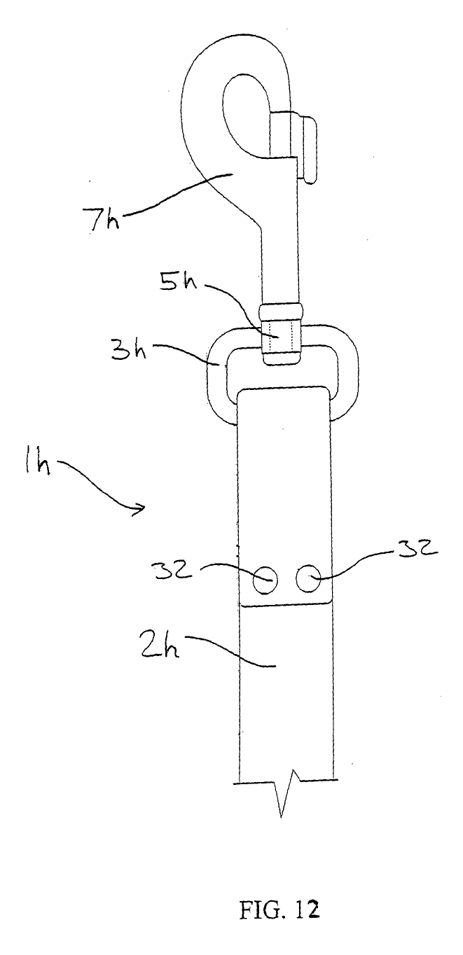

Referring now to FIG. 12 it will be seen that the pet lead 1h is very similar to that shown in FIG. 11 except that instead of a belt buckle 31, two press-studs 32 are used to close the end of strap 2h into a loop. Again, the studs 32 can be applied to the strap 2h at the point of sale. The press studs 32 can also be rivets or threaded studs.

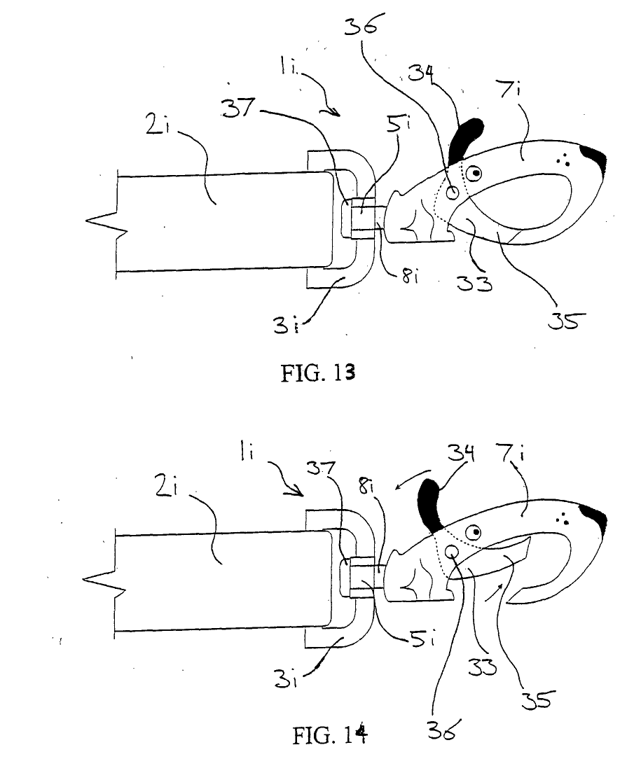

Turning now to FIGS. 13 and 14, a strap 2i is threaded through a shackle 3i, the shackle 3i having a collar 5i integrally formed thereon. The collar 5i is configured to receive a shank 8i that is integrally formed with a stylised clip 7i. The shank 8i has either a releasable head 37 (see eg FIGS. 1 & 2) which locks the clip 7i in engagement with the shackle 3i or the shank end is swaged over/flattened at 37.

In accordance with the invention, the clip 7i is configured in the shape of a dog and includes a latch 33 configured at one end in the shape of an ear 34 and at an opposite end in the shape of a jaw 35 of the dog. The latch 33 is pivotally mounted to the dog-shaped clip 7i via a pivot pin 36. The pivotal connection is such that by moving the ear portion 34 of the latch 33 towards the rear of the dog clip 7i, the jaw portion 35 moves to an open position as shown in FIG. 14. The latch 36 includes a spring which biases the latch 33 towards the closed position shown in FIG. 13.

Other parts of the dog's anatomy can also be used to similar effect.

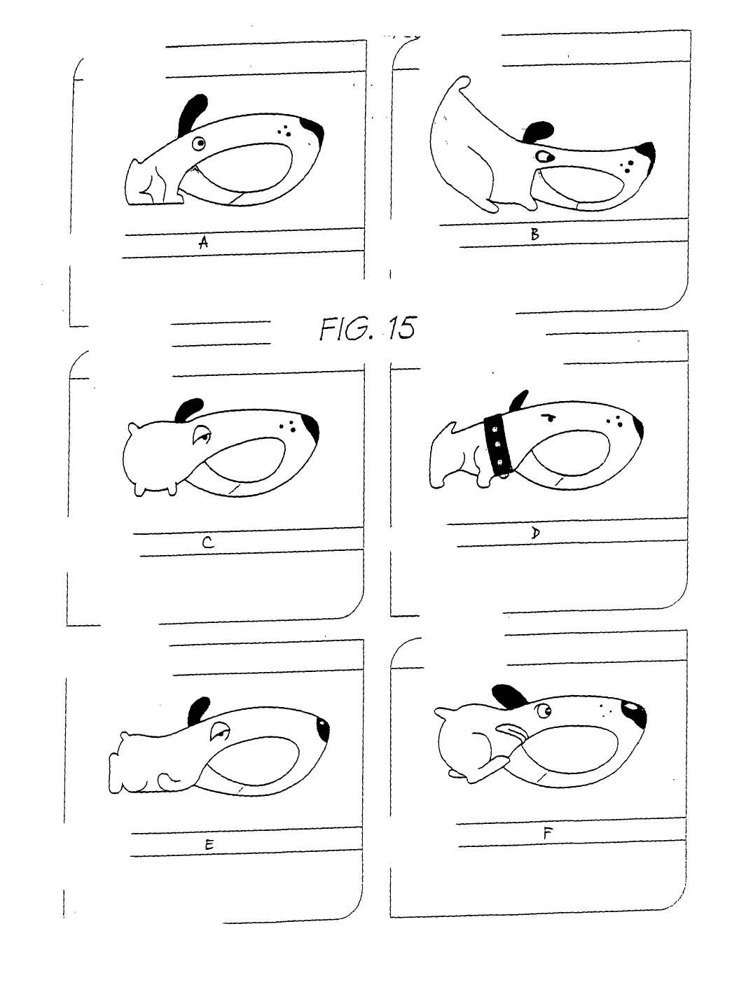

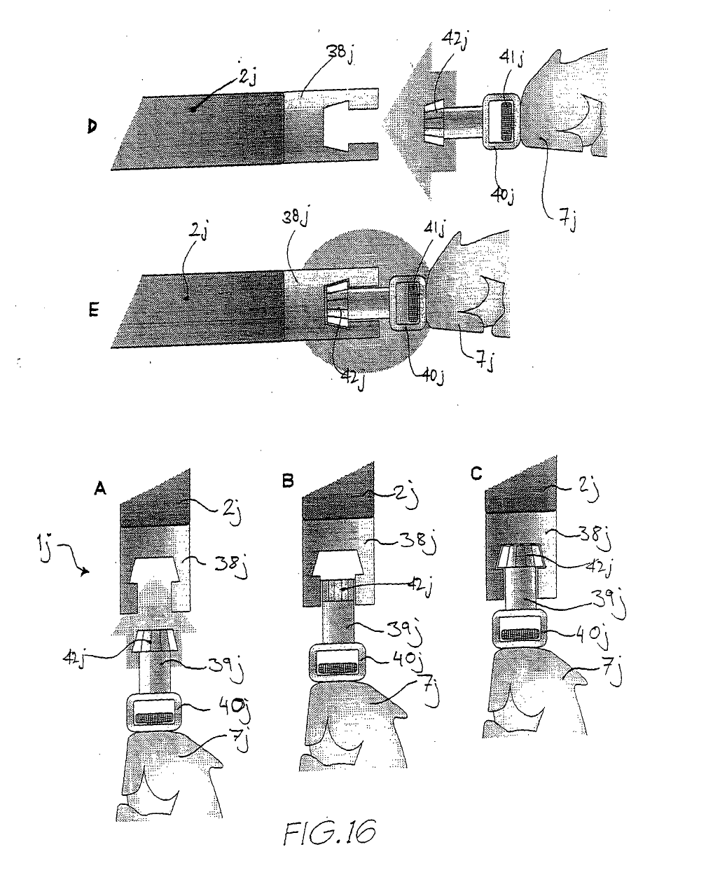

FIGS. 15A to F show alternative dog clip shapes to that of FIGS. 13 and 14, illustrating that a number of different aesthetic effects can be achieved with a clip, whilst preserving its functional aspects. In addition, the latch arrangements of FIGS. 13 to 15 are much easier to use by disabled, handicapped, arthritic etc persons, as attachment of the clip to a collar ring does not even require latch activation by a user (ie they may simply press the latch against the ring to open it). Furthermore, latch opening in the clips of FIGS. 13 to 15 is an easier action, merely requiring thumb sliding back over the ear portion 34. Hence both ergodynamic and aesthetic effects are achieved with these designs.

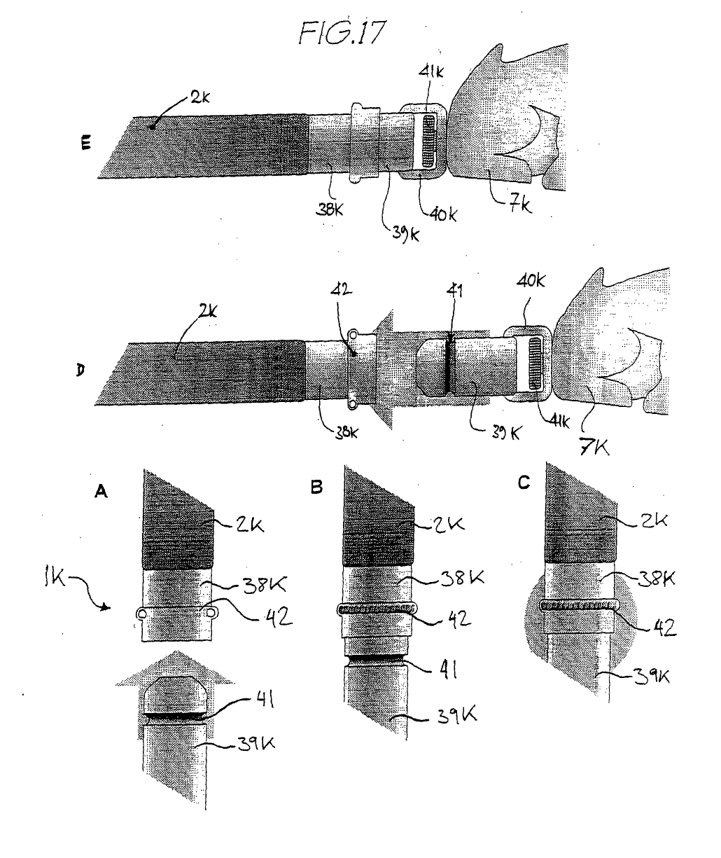

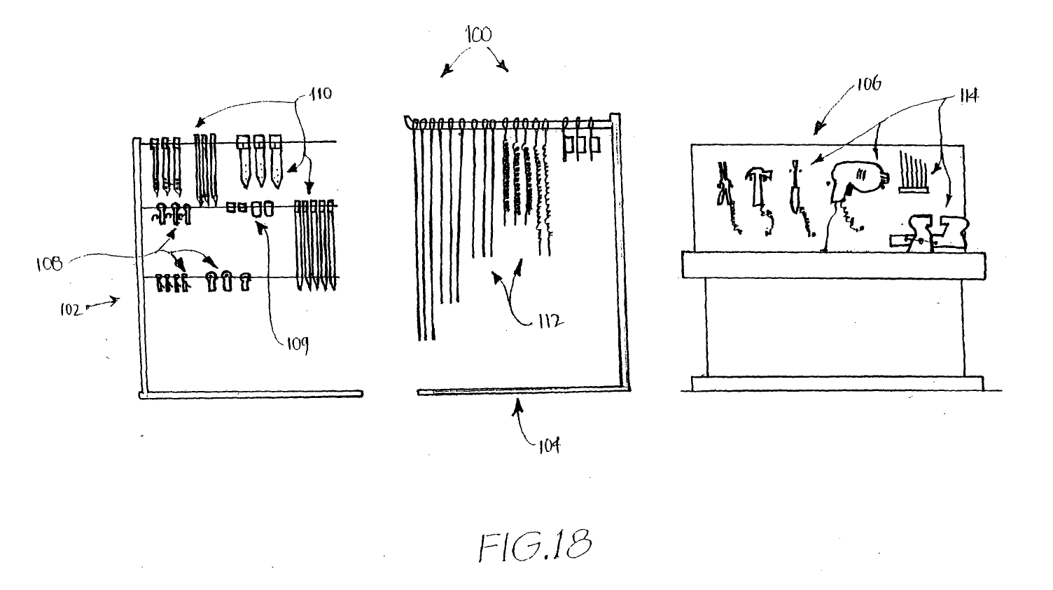

Referring now to FIGS. 16 and 17, again similar references numerals to those used in previous figures denote similar or like parts. FIGS. 16 and 17 show pet leads 1J and 1K, respectively. The pet leads 1J and 1K comprise straps 2J and 2K, female recess portions 38J and 38K, male insertion portions 39J and 39K, clips 7J and 7K and connecting shackles 40J and 40K respectively. The male insertion portion 39K is connected to pivot with respect to shackle 40K, whereas the male insertion portion 39J is integrally fastened to shackle 40K. Each shackle also rotates with respect to its respective clip about a boss 41J or 41K respectively.

In the embodiment of FIG. 16, typically an enlarged head 42J at the free end of the male insertion portion 39J is formed from a resilient (eg deformable or flexible) material which allows it to deform as shown in FIG. 16B as it is inserted into the female recess portion 38J. Once fully inserted, it then expands, generally returning to its original shape as shown in FIG. 16C to attach the male and female portions together. This arrangement thus provides a kind of snap-fit. FIGS. 16D and 16E respectively depict initial and final positions of the insertion action.

Alternatively or additionally, the female recess portion 38J can be formed from a resilient (eg deformable or flexible) material which allows it to flex outwardly during insertion of male insertion portion 39J.

Referring to FIG. 17, the male insertion portion 39K includes a circumferential recess in the form of groove 41 configured to receive a circular resilient spring 42, the spring 42 being housed within the female recess portion 38K. FIGS. 17A, 17B and 17C show the male insertion portion 39K in a disengaged, intermediate and fully engaged position, respectively, with the spring 42 riding around and being expanded by the male insertion portion 39K during its insertion into female recess portion 38K. Eventually the spring 42 aligns with, and rides and contracts into groove 41 to attach the male and female portions together. FIGS. 17D and 17E respectively depict initial and final positions of the insertion action. To further assist with attachment/detachment the male and female portions 39K and 38K can also be formed of resilient (eg deformable or flexible) materials as appropriate.

FIGS. 16 and 17 thus disclose embodiments whereby a clip can be easily and readily releasably attached to a strap of a lead.

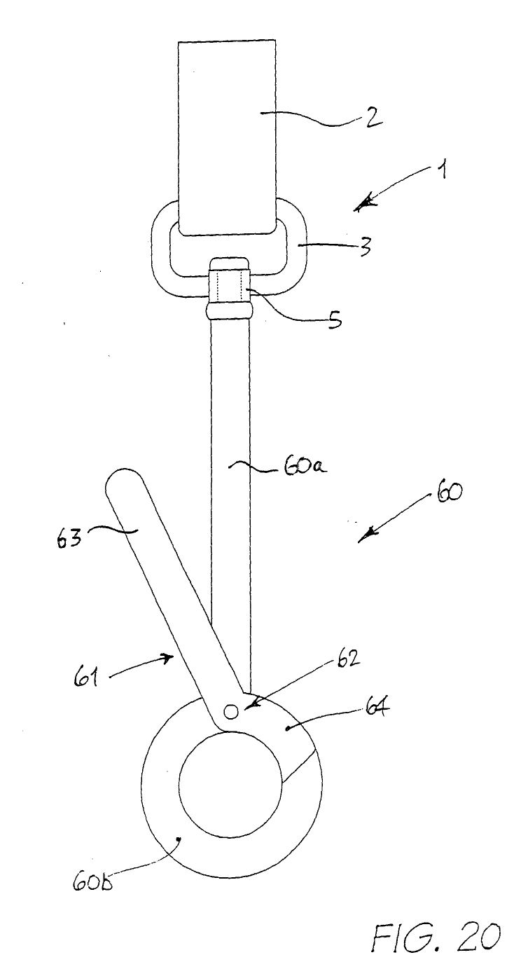

FIGS. 19 and 20 disclose two embodiments of modified clips according to the invention that can be more easily used by people with hand-related disabilities or having impaired strength or coordination (eg. that is age-related). FIG. 19 discloses a clip 45 having a conventional spring-loaded pin 46, but including a hook 50 extending from pin 46 and formed in a J or U-shape, which can be easily actuated by a persons finger. In this regard, the size of hook 50 may be such as to snugly receive a person's finger therein.

FIG. 20 discloses a new clip type 60. Clip 60 has elongate body 60a with a circular head 60b being defined at an end of body 60a. A lever arm 61 is pivotally mounted to the clip 60 via pivot pin 62. The lever arm 61 has a lever portion 63 and an opposing rounded gate portion 64 that is adapted to close an opening to the head 60b. The lever portion 63 extends away from the body 60a of the clip but such that the lever arm 61 can be easily grasped by a finger or hand of a person and pivoted, with little pressure, to actuate opening of the gate (ie. by pivoting gate portion 64 inwardly). In addition, like the clips in FIGS. 13 to 15, the gate portion can be pressed against a link, ring or shackle to open it, thus requiring little manual dexterity. The lever arm 61 is typically spring-biased into the position shown in FIG. 20.

The foregoing describes preferred embodiments of the present invention and modifications, apparent to those skilled in the art, can be made thereto without departing from the scope of the invention. For example, the preceding detailed description refers to embodiments of the invention relating to pet leads.

The invention may also be embodied by specific substantially analogous systems and methods relating to collars and by a variety of collar arrangements configured in a like or similar manner to the pet lead. For example, a collar is provided including a receiving portion which may be integrated into/defined at a collar strap and be configured to receive and engage with an insertion portion of a leash. The receiving and insertion portions may take the form of abovementioned clip to shackle attachment means such as those described with reference to FIGS. 1 to 14.

Furthermore, other types of releasable attachment mechanisms such as bayonet fittings, interference fittings etc can be employed. Also, other ergodynamic clip configurations and animal shapes can be employed (eg. cat shapes for cat leads).

The term “comprising” (and its grammatical variations) as used herein are used in the inclusive sense of “having” or “including” and not in the sense of “consisting only of”.

1. A system for selecting a pet lead or collar configuration at point of sale, the system comprising an arrangement for storing, in a disassembled configuration, a number of pet lead and/or collar components sufficient and configurable to assemble a pet lead and/or collar.

2. A system as claimed in claim 1, further comprising an assembly facility that enables components selected from the arrangement to be assembled into the pet lead and/or collar configuration at point of sale.

3. A system as claimed in claim 2 wherein the assembly facility is configured such that a purchaser of the lead or collar can assemble the components into a desired pet lead and/or collar configuration.

4. A system as claimed in claim 2 or 3 wherein the storage arrangement and assembly facility are positioned in proximity of each other such that selected components can be immediately assembled into a desired pet lead or collar configuration.

5. A system as claimed in any one of the preceding claims, wherein the pet lead components comprise a plurality of each of:
a clip configured for releasable attachment to a collar;
a leash for fastening attachment to the clip.

6. A system as claimed in claim 5, wherein the components additionally comprise a plurality of collars configured to be worn by a pet and a plurality of rings for attaching the clip to the collar.

7. A system as claimed in claim 5 or 6, further comprising a releasable attachment means for attaching the clip to a proximal end of the leash, the attachment means being associated with either or both of the clip and leash.

8. A system as claimed in any one of claims 5 to 7, wherein a distal end of each leash is configured to be held by a person.

9. A system as claimed in any one of the preceding claims, wherein the components are sufficient and configurable for manual assembly of the pet lead and/or collar.

10. A system as claimed in any one of claims 1 to 4, wherein the pet collar components comprise a plurality of each of:
an elongate member for forming into a loop to define a body of the collar; and
a coupling component fastenable to the elongate member and enabling releasable attachment to a leash.

11. A system for selecting a pet lead or collar configuration at point of sale substantially as herein described and with reference to the accompanying drawings.

12. A method for enabling selection of a pet lead or collar configuration, respectively at point of sale, comprising the step of, at point of sale, providing a number of pet lead or collar components sufficient and configurable to assemble a pet lead and/or collar.

13. A method as claimed in claim 12, comprising the further step of, at point of sale, providing for assembly of the selected components into the pet lead and/or collar configuration.

14. A method as claimed in claim 13, wherein the pet lead or collar components together with an assembly facility are provided in proximity of each other to enable selected respective components to be immediately assembled into a desired pet lead and/or collar configuration.

15. A method as claimed in any one of claims 12 to 14, wherein a purchaser of the lead or collar can assemble the respective components into a desired pet lead and/or collar configuration.

16. A method for enabling selection of a pet lead or collar configuration at point of sale, substantially as herein described and with reference to the accompanying drawings.

17. A pet lead comprising:
a clip configured for releasable attachment to a pet collar; and
attachment means for releasable attachment of the clip to an elongate member.

18. A lead as claimed in claim 17, wherein the elongate member has a shackle attached to one end, and the attachment means releasably connects the shackle with the clip.

19. A pet collar comprising a clip configured for releasable attachment to a pet lead, identification tag or other collar depending object, and the clip being attached to an elongate member of the collar.

20. A collar as claimed in claim 19, wherein the elongate member has a shackle attached thereto, and the attachment means releasably connects the shackle with the clip.

21. A lead or collar as claimed in claim 18 or 20, wherein the attachment means comprises:
a male portion mountable to the shackle or clip; and
a female portion mountable to the clip or shackle respectively and adapted for receiving the male portion therein such that, when engaged, the male and female portions attach the clip and shackle together.

22. A lead or collar as claimed in claim 21, wherein part of the male portion is externally threaded and part of the female portion is internally threaded, for screw coupling together of the male and female portions.

23. A lead or collar as claimed in claim 21 or 22, wherein a sleeve is mounted on the shackle or clip, with the female portion being inserted into one end of this sleeve and the male portion being inserted into an opposite end of this sleeve.

24. A lead or collar as claimed in claim 23, wherein the female portion is snugly received in the sleeve whereas the male portion has an enlarged head protruding out beyond the female portion and sleeve.

25. A lead or collar as claimed in claim 21, wherein the male portion is a shank and the female portion is a sleeve, the shank being insertable through the sleeve such that a free end protrudes therebeyond, with the shank free end comprising a groove that is adapted for engagement by a circlip that has a perimeter greater than an inner dimension of the sleeve.

26. A lead or collar as claimed in claim 21, wherein the male portion is a shank and the female portion is a sleeve, the shank being insertable into the sleeve such that a free end is located within the sleeve, the shank free end comprising a groove that is alignable with a slot defined in a side wall of the sleeve, the groove being adapted for engagement by a circlip insertable through the slot whereby, once the circlip is inserted through the slot and engaged on the groove, it locks the shank in the sleeve.

27. A lead or collar as claimed in claim 21, wherein the male portion is a shank having a lug at a free end thereof and the female portion is a sleeve having a slot in a side wall thereof that is shaped to laterally receive the shank and lug therethrough and allow the lug to move longitudinally to a seat, from where it must be moved longitudinally then laterally to be removed from the sleeve, the attachment means further comprising a plug shaped for fastening receipt in the sleeve slot whereby, once the shank and lug have been inserted through the slot, the plug can be inserted and fastened into the slot to lock the shank and lug in the sleeve.

28. A lead or collar as claimed in claim 27, wherein the plug has opposing projecting fingers, each having a hooking means at a free end thereof, and wherein an internal wall of the sleeve has corresponding holes defined therethrough, each hole for receiving a respective hooking means therein to fasten the plug in the sleeve when it is inserted into the slot.

29. A lead or collar as claimed in claim 27 or 28, wherein a portion of the shackle extends through the sleeve, whereby the lug can sit under the shackle portion whereas part of the plug extends over the shackle portion, to thereby sandwich the shackle portion between the lug and plug part.

30. A lead or collar as claimed in claim 20, wherein the shackle is in the form of a karabiner, joined to or integrally formed with an end of the clip, and through an opening of which a looped end of the elongate member may be passed.

31. A lead or collar as claimed in claim 30, wherein a sleeve is mounted to the karabiner, and a shank extends from the clip and is inserted through the sleeve such that a free end protrudes therebeyond, the shank free end being swaged so as to have a perimeter that is greater than an inner dimension of the sleeve to thereby fasten the clip to the karabiner.

32. A lead or collar as claimed in claim 17 or 19, wherein an end of the elongate member is looped and the attachment means comprises:
a shackle which passes through the loop or an aperture in the clip; and
a pin for the shackle which passes through the aperture in the clip or loop respectively.

33. A lead or collar as claimed in claim 32, wherein the pin has a threaded end and an opposing enlarged head, the threaded end being screwable into a threaded recess defined at a free end of one arm of the shackle, and the enlarged head being restrained at a recess defined at a free end of another arm of the shackle.

34. A lead or collar as claimed in claim 31 or 32, wherein the shackle is U-shaped.

35. A lead or collar as claimed in claim 17 or 19, wherein the attachment means comprises a link for connecting the clip and elongate member together, the link being mounted to or integrally formed with the clip or extending through an aperture in the clip, and also extending through a looped end of the elongate member, the looped end of the elongate member being enabled by a shackle and pivot pin arrangement in which a free end of the elongate member is looped back through the shackle and the pivot pin of the shackle is inserted through a hole in the free end to lock the same against movement in the shackle.

36. A lead or collar as claimed in claim 17 or 19, wherein the attachment means comprises a link for connecting the clip and elongate member together, the link being mounted to or integrally formed with the clip or extending through an aperture in the clip, and also extending through a looped end of the elongate member, the looped end of the elongate member being defined by folding back a free end of the elongate member and releasably fastening it against an adjacent part of the elongate member.

37. A lead or collar as claimed in claim 36, wherein the elongate member free end is releasably fastened against the adjacent part through the arrangement of one or more press studs, rivets or threaded studs therebetween.

38. A lead or collar as claimed in any one of claims 35 to 37, wherein the link is a closed oval-shaped or rectangular ring.

39. A lead or collar as claimed in claim 17 or 19, wherein the attachment means comprises a first link that extends through a looped end of the elongate member and a second link mounted to or integrally formed with the clip or extending through an aperture in the clip, with one of the first or second links being connected to a stem of a T-piece, and the other of the second or first links being connected to a body having a T-shaped slot defined therein for receipt of the T-piece to connect the first and second links together.

40. A lead or collar as claimed in claim 39, wherein the T-piece and body are each elongate, with the T-shaped slot extending longitudinally through the body and defining a T-shaped opening to the slot at an end thereof through which the elongate T-piece can be slid to connect the first and second links together.

41. A lead or collar as claimed in claim 39 or 40, wherein a grub screw or pin can be mounted to extend through the T-piece and into the body when the T-piece is located in the body to lock the first and second links together.

42. A lead or collar as claimed in claim 17 or 19, wherein the attachment means comprises:
a body having a hollow interior and an aperture to that interior, the body connected to the elongate member or clip; and
a shank with a lug at a free end thereof, the lug having a greater cross-sectional dimension than that of the aperture, but sized to fit within the body hollow interior, the shank being connected to the clip or elongate member respectively;
wherein at least one of the lug and/or body is deformable or flexible such that the lug can be inserted through the aperture and into the hollow interior, to connect the elongate member and clip together.

43. A lead or collar as claimed in claim 17 or 19, wherein the attachment means comprises:
a body having a hollow interior and an aperture to that interior, with a ring element locatable within the hollow interior, the body connected to the elongate member or clip; and
a shank having a groove for receiving the ring element therein, the groove located adjacent to a free end of the shank, the shank being connected to the clip or elongate member respectively;
wherein at least one of the shank and/or ring element is deformable or flexible such that the shank can be inserted through the aperture and into the hollow interior until the ring element rides into the groove to connect the elongate member and clip together.

44. A lead or collar as claimed in claim 43, wherein the ring element comprises a circular spring which is deformed as the shank moves therepast, and which springs into the groove once it is aligned therewith.

45. A collar as defined in any one of claims 21 to 44, wherein the elongate member is a strap.

46. A lead as defined in any one of claims 17 or 21 to 44 when dependant on claim 17, wherein the elongate member is a leash or strap that includes a handle at a remote end thereof.

47. A lead or collar as claimed in any one of claims 17 to 46, wherein the clip has a spring-loaded pin defining a gateway to an aperture of the clip, and wherein a protruding hook extends outwardly from the pin and is adapted for receiving a user's finger thereat to enable urging of the pin against the spring to open the gateway.

48. A lead or collar as claimed in claim 47 wherein the hook is J or U-shaped and is sized to receive a user's finger snugly therein.

49. A lead or collar as claimed in any one of claims 17 to 48, wherein a gateway to an aperture of the clip is defined by an elongate member pivotally mounted intermediate its ends to the clip to define a lever portion of the member extending away from the clip that can be actuated by a user's hand, with an opposite end of the member defining a gate portion to the gateway that can be pivoted open and closed by actuation of the lever.

50. A lead or collar as claimed in claim 49 wherein the clip has an elongate body with a head at a remote end thereof, the head defining the aperture and the gateway thereto, and wherein the elongate member is pivotally mounted to the clip adjacent to the head such that the lever portion extends from one side of the clip body and the gate portion extends from an opposite side.

51. A lead or collar as claimed in claim 50 wherein the elongate member is biased by a spring into the gateway closed position.

52. A clip for a pet lead, the clip being as defined in any one of claims 47 to 51.

53. A pet lead or collar substantially as herein described with reference to the drawings.

54. An attachment means for use with a pet lead or collar for attaching a clip of the pet lead or collar to an elongate member of the pet lead or collar, the attachment means being as defined in any one of claims 17 to 44.

55. An attachment means for a pet lead substantially as herein described with reference to FIGS. 1 to 12, 17 or 18 of the drawings.

56. A clip for a pet lead or collar, characterised in that the clip is configured in the shape of an animal, and a portion of the animal's anatomy is mechanically associated with the operation of the clip.

57. A clip as claimed in claim 56, wherein the portion of the animal's anatomy comprises a latching means for opening the clip and enabling it to be clipped onto a shackle or ring, characterised in that opposing portions of the latching means are configured in the shape of an ear and a jaw of the animal such that, by moving the ear portion of the latching means, the jaw portion of the latching means can move between open and closed positions.

58. A clip as claimed in claim 57, wherein the latching means is a lever arm pivotally mounted intermediate its ends to a remainder of the clip, with one end of the lever arm defining a protruding ear of the animal shape for manual engagement by a user, and the other end of the lever arm defining a jaw portion of the animal shape that can move to open onto an open mouth portion of the animal shape and into which a loop of a shackle or ring can be located.

59. A clip for a pet lead and/or collar substantially as herein described with reference to FIGS. 13 to 18, 20 and 21 of the drawings.

60. A method of assembling the lead or collar of claims 27 to 29, comprising the steps of:
(a) laterally inserting the lug and shank into the slot;
(b) longitudinally moving the shank away from the shackle so that the lug becomes seated in the sleeve; and
(c) inserting and thereby fastening the plug into the slot to secure the lug in the sleeve and to sandwich a portion of the shackle between the lug and plug.

61. A pet collar comprising a clip configured for releasable attachment to a pet lead, identification tag or other collar depending object, and the clip being attached to an elongate member of the collar.
